(19) United States
(12) Patent Application Publication
(10) Pub. No.: US 2007/0204835 A1
(43) Pub. Date: Sep. 6, 2007

(54) Fuel Injection Nozzle

(76) Inventors: Daguang Xi, Hangzhou (CN); Yanxiang Yang, Hangzhou (CN); Changwen Liu, Hangzhou (CN)

Correspondence Address: JACOBSON HOLMAN PLLC, 400 SEVENTH STREET N.W., SUITE 600, WASHINGTON, DC, 20004, US

(21) Appl. No.: 11/660,410

(22) PCT Filed: Jul. 4, 2005
(86) PCT No.: PCT/CN05/00969

§ 371 Date: Feb. 16, 2007

(30) Foreign Application Priority Data
Dec. 15, 2004 (CN) 200410089530.4

(51) Int. Cl. F02M 69/00

(52) U.S. Cl. 123/445

(57) ABSTRACT

A fuel injection nozzle, generally relating to the field of internal combustion engine, comprises a nozzle body, a fuel valve and a guide cap, wherein when the fuel pressure in said nozzle body exceeds the predetermined level, said fuel valve opens and the fuel therein is injected out via said guide cap, featuring that said fuel valve comprises a valve body, a valve seat and a spring, wherein the space between the rear end of said valve seat and said nozzle body defines the fuel cavity, an intake port to introduce fuel into said fuel cavity is opened in said nozzle body, said spring is disposed between said valve body and said valve seat in the fuel cavity to keep said fuel valve normally closed, the volume between the front end of said valve seat and said guide cap defines a residual space, and one or more orifices communicated with said residual space are opened in said guide cap. The present invention illustrates a brand new type of fuel injection nozzle for pulsed fuel pumps applied in electrically-controlled fuel injection systems, which has the characteristic of simple construction and small size, great freedom of spray direction design and the seat face not being directly scorched by flames in the combustion chamber.

### FIELD OF THE INVENTION

The present invention generally relates to the field of internal combustion engines, particularly to fuel injection nozzles for pulsed type fuel pumps applied in electrically-controlled fuel injection systems.

### THE PRIOR ART

The intake-port injection system specified in a Chinese patent (publication No. CN1474910A) and the in-cylinder direct injection system specified both in a Chinese patent (publication No. CN1369633) and an American patent (publication No. US6422836B1) generally employ an electrically-controlled pulsed fuel injection apparatus. The aforesaid electrically-controlled pulsed fuel injection apparatus consists of a pulsed pump and a fuel injection nozzle which conjunctly define an unit injector or a pump-pipe-nozzle unit wherein the pump and nozzle are communicated via a high-pressure fuel pipe. The fuel injection nozzle employed in pulsed pumps is expected to be of small size and simple construction, the spray direction thereof can be freely designed and the seat surface thereof can avoid being directly scorched by the flames.

The aforementioned electrically-controlled pulsed fuel injection apparatus generally employ a type of push-out needle nozzle. There are two types of needle nozzles, one of which is a draw-in needle nozzle with the open direction thereof being opposite to the spray direction generally employed in some earlier pre-combustion diesel engines, and the other one of which is a push-out needle nozzle with the open direction thereof being the same with the spray direction. The construction of push-out needle nozzles is much simpler compared with that of the draw-in ones, but push-out needle nozzles have some apparent drawbacks as follows: firstly, the spray-cone thereof must be coaxial with the fuel valve so that the injection system cannot be designed freely; secondly, the nozzle seat is exposed outside which can reduce the service life thereof. The first drawback of the aforementioned push-out needle nozzle greatly restricts the application of pulsed type fuel injection systems. As illustrated by the application of the pulsed type unit injector in motorcycle engines, it is very difficult to design the intake ports of the engines because of the restriction of the spray direction of said injection nozzle. In the application of in-cylinder direct injection outboard engines, the direct exposure of the seat surface of the nozzle to the flames in combustion chambers may result in serious problems such as the subsidence of sealing seats thereof.

In the prior art, the spray direction of multi-orifice nozzles can be freely designed and the seat thereof can avoid being directly scorched by flames in combustion chambers. Therefore such multi-orifice nozzles are extensively applied in the fuel injection system of reciprocating piston engines, which comprise a fuel valve and one or more orifices wherein the fuel valve primarily consists of a valve needle and a valve seat which are substantially high-precision fitting components, especially for the valve seat of a center hole-seat construction which is difficult to manufacture. The most troublesome drawbacks of the multi-orifice nozzle are of large size, complex construction and high cost.

Therefore, none of the prior fuel injection nozzles is ideal for the aforesaid electrically-controlled pulsed fuel injection apparatus to simultaneously meet the requirements of small size, simple construction, low cost, freely designed spray-direction, and the valve seats being not scorched by flames in combustion chambers. Consequently, a brand new type of fuel injection nozzle is imperative to meet the demands of pulsed fuel pumps employed in electrically-controlled fuel injection system of engines.

### SUMMARY OF THE INVENTION

As to the problems described thereinbefore, the objective of the present invention is to provide a new type of fuel injection nozzle of a compact construction, wherein the fuel spray direction can be freely designed and the seat surface thereof can avoid being scorched by flames in the combustion chamber.

The objective of the subject invention is attained by the following constructions:

An injection nozzle comprises a nozzle body, a fuel valve and a guide cap, wherein when the fuel pressure in the nozzle body exceeds a predetermined level, the fuel valve opens and the fuel therein is injected out via the guide cap, featuring that the fuel valve comprises a valve body, a valve seat and a spring, wherein the space between the rear end of said valve seat and said nozzle body defines the fuel cavity, an intake port for introducing fuel into said fuel cavity is opened in said nozzle body, the spring is disposed between said valve body and said valve seat in said fuel cavity to keep the fuel valve normally closed, the volume between the front end of said valve seat and said guide cap defines a residual space (sac volume), and one or more orifices communicated with said residual space are opened in said guide cap.

The fuel valve of the fuel injection nozzle provided in the present invention opens under the fuel pressure in the fuel cavity and closes under the restoring force of the spring disposed between the valve body and the valve seat in the fuel cavity, such a valve body-spring-seat construction thereby making the fuel valve a compact integration.

The seat surface of the valve seat of the fuel injection nozzle provided in the present invention may be either an inner conical surface with its bigger end facing the residual space, or a planar surface. According to the relations between the spring to the valve body and the valve seat, the opening direction of the valve body under fuel pressure must be the same with that of the fuel flow, therefore it is preferable to design the valve seat surface as a conical surface with its bigger end facing the residual space, which can not only ensure high sealing capacity, but also afford the resetting impact of the valve body. In case of low opening pressure for the fuel valve, the front end plane of the valve seat can be designed as the seat surface which can be made of sealing materials.

The seat surface of the valve body provided in the present invention can be an outer conical surface with its bigger end facing the residual space, or a spherical surface. The outer conical surface of said valve body and the inner conical surface of said valve seat can be of the same cone angle thereby to enhance the abradability thereof; otherwise different cone angles may be respectively designated for each of them to improve the sealing capacity thereof. Designing the seat surface as a spherical one may simplify its manufacturing process.

The lift of the valve body provided in the present invention can be set either by adjusting the distance between the spring seat of said valve body and the end surface of said valve seat, or by adjusting that between the end surface of said valve body and inner wall of said guide cap in the residual space. The lift of the valve body can have a great influence on the fuel flux of the fuel injection nozzle. The former lift adjusting method is helpful to nozzle integration, but the latter one can enhance the operating reliability thereof.

The volume and shape of said residual space of the present invention can be adjusted by changing the dimensions of the shoulder disposed at the front end of the valve body. The volume and shape of the residual space has a great influence on the quantity and quality for each injection of fuel spray; provided that the demanded quantity for each injection is satisfied, a smaller residual space will benefit the combustion of the engines.

In the present invention, a fuel hole is opened in the valve seat, surrounded by a filtering mesh screen, only via which can the fuel enter the portion where the valve body fits with the valve seat in high precision. The filtering mesh screen is the last means to filter out impurities in fuel which have a great influence on the high-precision fitting between said valve body and said valve seat.

The spray direction of the injection orifice provided in the present invention can be perpendicular to or parallel with the axis of the fuel valve, or even an arbitrary angle may be kept thereinbetween, and therefore the spray direction can be freely designed. The fuel spray direction is crucial to the combustion system of engines. In the case of intake port injection, the fuel must be directly injected toward the intake valve, but for the direct injection combustion systems, the fuel must be directly or indirectly injected to the space surrounding spark plug(s). The present invention overcomes the drawback of the inconvenient spray direction design in the pulsed fuel injection apparatus by the prior art.

A check valve is provided at the inlet of the intake port of said injection nozzle to keep a proper residual pressure in said fuel cavity and thus to prevent the generation of fuel vapor in case of high temperature which can disturb the normal fuel injection.

One preferred embodiment for the fuel injection nozzle provided in the present invention is that a check valve is disposed at the inlet of said intake port to keep a proper residual pressure in said fuel cavity and to prevent the generation of fuel vapor due to high temperature, the seat surface of said valve seat is an inner conical surface with its bigger end facing the residual space and that of said valve body is an outer one with its bigger end also facing the residual space, a spring seat is provided in the valve body and the lift of said valve body is determined by the distance between said spring seat and the end face of said valve seat, a fuel hole surrounded by a filtering mesh screen to introduce fuel into the fuel valve is opened in said valve seat, the axis of which is perpendicular to that of the fuel valve.

In general, the first fundamental feature for the fuel injection nozzle provided in the present invention is that a spring is disposed between said valve body and said valve seat in the fuel cavity to keep the fuel valve normally closed; the second fundamental feature thereof is that a guide cap is provided at the front end of said fuel valve to protect the seat surface of the nozzle from being scorched by flames in engine combustion chamber; the third fundamental feature thereof is that one or more injection orifices can be opened in the guide cap and thereby the spray direction and spray range of the nozzle can be freely designed.

### DETAILED DESCRIPTION OF THE DRAWINGS

The invention will be better understood if read in conjunction with the appended drawings and preferred embodiments.

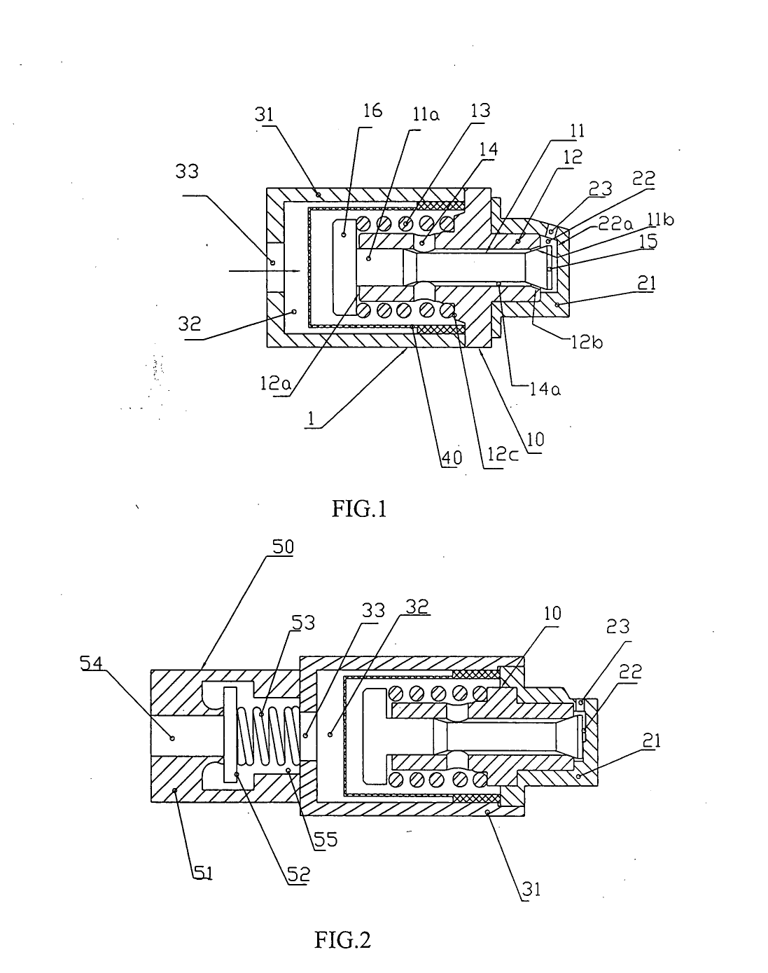

FIG. 1 is a longitudinal sectional view of the fuel injection nozzle for a first embodiment provided in the present invention;

FIG. 2 is a longitudinal sectional view of the fuel injection nozzle for a second embodiment provided in the present invention;

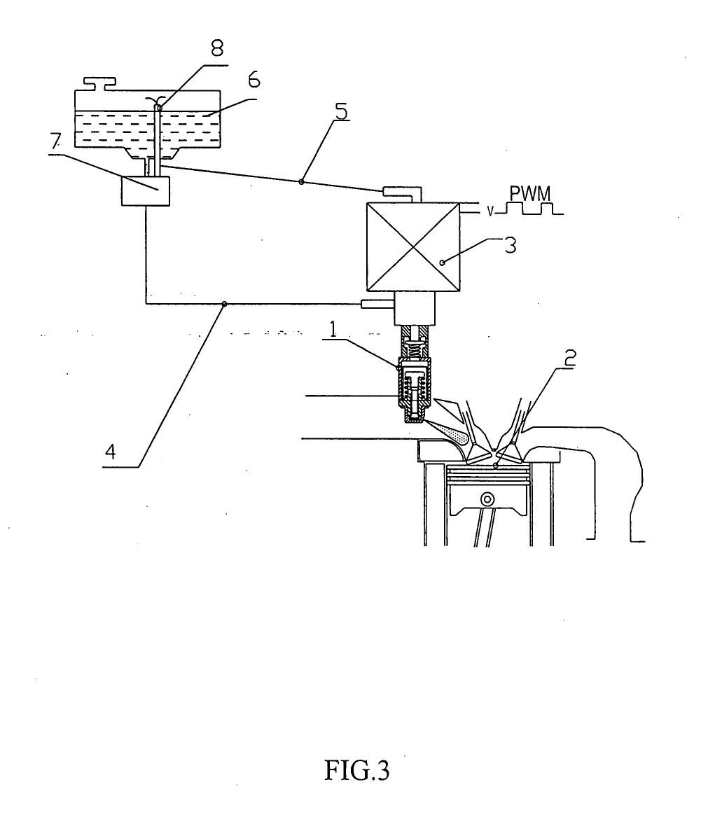

FIG. 3 is a practical application of the fuel injection nozzle provided in the present invention.

### DETAILED DESCRIPTION OF THE PREFERRED EMBODIMENTS

FIG. 1 depicts the construction for a first embodiment of the fuel injection nozzle provided in the present invention.

The fuel injection nozzle depicted in FIG. 1 comprises a fuel valve 10, a nozzle body 31 and a guide cap 21 disposed at the front end of the valve seat 12.

The fuel valve 10 comprises a valve body 11, a valve seat 12 and a spring 13, wherein said valve body 11 mainly comprises a valve stem 11a functioning as a motion and fuel flow guiding means, a seat surface 11b and a spring seat 16. The valve seat 12 comprises a channel 14a in sliding fit with the valve stem 11a, a seat surface 12b, a spring seat 12c and fuel hole 14. Said fuel valve 10 is connected with said nozzle body 31 on one side thereby to define a fuel cavity 32 of the fuel injection nozzle, and connected with said guide cap 21 on the other side thereby to define a residual space 22.

One end of the spring 13 presses against the spring seat 16 disposed on the valve body 11, and the other end thereof against the spring seat 12c disposed on the valve seat 12. Under the pretightening force of said spring 13, the seat surface 11b of said valve body 11 makes close contact with the seat face 12b thereby to make the fuel valve 10 be in normally closed state. A passage is provided between the valve stem 11a and the valve seat 12, and the fuel in the fuel cavity 32 can flow to the seat surfaces 11b/12b via said passage and said fuel hole 14.

The fuel valve 10 can be opened by the fuel pressure. The spring 13 is disposed within the fuel cavity 32 and is compressed between the valve body 11 and the valve seat 12, making the fuel valve a compact integration thereby to minimize its size, the length thereof being within 30 mm, for example. The above described construction is much preferable to that of the prior multi-orifice nozzles wherein the spring 13 is disposed between the valve body 11 and the nozzle body 31.

Injection orifice 23 is opened in the guide cap 21, communicating with the residual space 22. The spray direction of said injection orifice 23 can be perpendicular to or make any angle to the axis of the fuel valve, according to injection direction requirements. More than one injection orifice can be opened to enhance the quality of fuel atomization, facilitate the adjustment of spray direction and rationalize the distribution of the fuel spray. The fuel injection nozzle with the feature that the spray direction of said injection orifice can be designed perpendicular to the axis of the fuel valve 10 is greatly helpful for applying the injection system on motorcycles because without the abovementioned feature, restrictions to the freedom of fuel injection and air intake system may make the whole construction of motorcycles to be totally redesigned, or even deterioration of the performance of motorcycle engines is inevitable. With the present invention, the injection system will be easily applied to most 125 cc displacement motorcycles with few changes in construction.

The seat surface 11b of the valve body 11 locates nearer to the residual space 22 compared to the seat surface 12b of the valve seat 12, When the force on valve body 11 acted on by fuel pressure of the fuel cavity 32 exceeds the pretightening force of the spring 13, the valve body 11 begins to move towards the residual space 22 and thereafter the fuel valve 10 is opened.

The seat surface 12b of the valve seat 12 is an axisymmetrical inner conical surface with its bigger end facing the residual space 22. The seat surface 11b of the valve body 11, which is an outer conical surface with its bigger end facing the residual space 22 as well, mates with said seat surface 12b of the valve seat 12, thereby to define a sealing ring.

A cylindrical shoulder 15 is disposed at the bigger end of the conical surface of the valve body 11, fitted geometrically with the residual space 22, such that a fuel passage is defined inside the residual space 22 thereby to minimize the volume thereof.

The fuel hole 14 is surrounded by a filtering screen 40 and only via said filtering screen can the fuel flow to the channel 14a, the high precision seat surfaces 11b and 12b and so on.

The lift of the valve body 11 can be limited either by the end surface 12a of the valve seat 12 or by the inner wall 22a of the residual space 22. The former is adopted for the present embodiment.

For the fuel injection nozzle illustrated in the subject embodiment, the typical operating process is as follows: the fuel from the intake port 33 enters the fuel cavity 32 and when the fuel pressure acted on the valve body 11 overcomes the pretightening force of the spring 13, said valve body 11 moves towards the residual space 22 and the fuel valve 10 opens thereafter; afterwards the fuel enters the residual space 22 of the fuel valve 10 via the filtering screen 40 and the fuel hole 14 in sequence, and then it is injected out via the injection orifice 23; the valve body 11 reaches its maximum lift which is limited by the end surface 12a; when the force from fuel pressure acted on the valve body 11 is lower than the pretightening force of the spring 13, the valve body 11 begins to reset, the fuel valve closes thereafter and a fuel injection cycle comes to an end.

FIG. 2 depicts the construction for a second embodiment of the fuel injection nozzle provided in the present invention.

A check valve 50, comprising a valve seat 51, a valve body 52 and a spring 53, is disposed at the inlet of said intake port 33 of the fuel injection nozzle as illustrated in FIG. 2. One end of said spring 53 presses said valve body 52 onto the sealing surface of said valve seat 51 while the other end thereof onto said nozzle body 31. The fuel cavity 55 of the check valve 50 is communicated with said fuel cavity 32 via the constantly open intake port 33. The objective to dispose said check valve 50 at said intake port 33 is to keep a residual fuel pressure in the fuel cavity 32 after fuel injection terminates and to prevent the vaporization of the fuel at high temperature.

The construction of the residual space 22 depicted in FIG. 2 can facilitate the flowing of the fuel and reduce the volume of the residual space as well.

The guide cap 21 depicted in FIG. 2 is integrated with said nozzle body 31, wherein the fuel valve 10 is disposed to separate said fuel cavity 32 and said residual space 22.

See embodiment 1 for other detailed aspects.

A practical application:

FIG. 3 illustrates a typical application of the fuel injection nozzle provided in the present invention, wherein the electrically-controlled pulsed fuel pump 3 is in conjunction with the fuel injection nozzle 1 thereby to define a fuel injection unit for the intake port injection system of a gasoline engine.

In the illustrated system, the fuel from the fuel tank 6 is filtered and then introduced into said electrically-controlled pulsed fuel pump 3 via the vapor-liquid separator 7 and the low-pressure fuel tube 4. Energized by PWM voltage-current waves, one part of the fuel is pumped to the fuel injection nozzle 1 by said fuel pump 3 and thereafter injected into the intake port of the illustrated engine 2 and the other part of pumped fuel is introduced back into said fuel tank 6 via the return tube 5. A vapor discharge pipe is also provided in said fuel tank 6.

The above-illustrated system is also applicable to in-cylinder direct injection engines and those engines consuming substitute fuels, in which case the fuel injection nozzle 1 directly injects the fuel into engine cylinders.

The apparent advantage of the fuel injection nozzle employed in the illustrated system specified in the subject invention is that interference between the electronically-controlled pulsed fuel pump 3 and other vehicle parts due to geometrical limitations and requirements for working condition of said fuel pump 3 can be effectively solved by convenient design of the spray direction of the fuel injection nozzle according to the present invention.

1. A fuel injection nozzle comprises a nozzle body, a fuel valve and a guide cap, wherein when the fuel pressure of the fuel cavity in said nozzle body exceeds the predetermined level, said fuel valve opens and the fuel is injected out via said guide cap, featuring that said fuel valve comprises a valve body, a valve seat and a spring, wherein the space between the rear end of said valve seat and said nozzle body defines a fuel cavity, an intake port for admitting fuel into said fuel cavity is disposed in said nozzle body, said spring is disposed between said valve body and said valve seat in the fuel cavity to keep said fuel valve normally closed, the volume between the front end of said valve seat and said guide cap defines a residual space and one or more injection orifices communicated with said residual space are opened in said guide cap.

2. The fuel injection nozzle of claim 1, wherein the seat surface of said valve seat is an inner conical surface with its bigger end facing said residual space.

3. The fuel injection nozzle of claim 2, wherein the seat surface of said valve body is an outer conical surface with its bigger end facing said residual space.

4. The fuel injection nozzle of claim 2, wherein the seat surface of said valve body is spherical in shape.

5. The fuel injection nozzle of claim 1, wherein the lift of said valve body is limited by the end face of said valve seat.

6. The fuel injection nozzle of claim 1, wherein the lift of said valve body is limited by the inner wall of the residual space of said guide cap.

7. The fuel injection nozzle of claim 1, wherein a shoulder is disposed at the front end of said valve body in said residual space.

8. The fuel injection nozzle of claim 1 wherein a fuel hole surrounded by a filtering mesh screen is opened in said valve seat to introduce fuel into said fuel valve.

9. The fuel injection nozzle of claim 1 wherein the axis of said injection orifice is perpendicular to that of said fuel valve.

10. The fuel injection nozzle of claim 1 wherein a check valve is disposed at the inlet of said intake port.

11. The fuel injection nozzle of claim 1 wherein a check valve is disposed at the inlet of said intake port, the seat surface of said valve seat is an inner conical surface with its bigger end facing said residual space, the seat surface of said valve body is an outer conical surface with its bigger end facing said residual space, the lift of said valve body is limited by the end face of said valve seat, a fuel hole surrounded by a filtering mesh screen is opened in said valve seat to introduce fuel into said fuel valve, and the axis of the injection orifice is perpendicular to that of said fuel valve.
